(19) United States
(12) Patent Application Publication
(10) Pub. No.: US 2004/0113301 A1
(43) Pub. Date: Jun. 17, 2004

(54) Method for producing two-membered or multi-membered all-ceramic dental shaped parts and corresponding device

(76) Inventors: Goran Burger, Pforzheim (DE); Stefan Knoll, Stuttgart (DE); Jurgen Laubersheimer, Karlsbad (DE)

Correspondence Address: NATH & ASSOCIATES, 1030 15th STREET, 6TH FLOOR, WASHINGTON, DC, 20005, US

(21) Appl. No.: 10/472,562

(22) PCT Filed: Dec. 22, 2001
(86) PCT No.: PCT/EP01/15295

(30) Foreign Application Priority Data
Mar. 26, 2001 (DE) 101-15-820.3

(51) Int. Cl. A61C 13/00

(52) U.S. Cl. 264/16; 205/67

(57) ABSTRACT

In a method for producing two-membered or multi-membered all-ceramic dental shaped parts, such as framework elements for bridges and the like, a model is first produced from the basic structure for which the dental shaped part is intended. With the aid of this model and a suspension of ceramic particles, a ceramic green body is formed, in particular by electrophoretic deposition, and is subsequently sintered. In said method, at least some of the dimensions of the model are selected so that the shrinkage which occurs during sintering of the green body is compensated, in order in this way to achieve the desired fit between dental shaped part and basic structure.

The invention relates first to a method for producing two-membered or multi-membered all-ceramic dental shaped parts, in particular framework elements for bridges and the like.

Ceramic or “porcelain” has always been an attractive material for reproducing teeth with a very tooth-like appearance in terms of shape and color. Ceramic is a chemically resistant, corrosion-resistant and biocompatible material which, in addition, is available in mineral form, in virtually unlimited quantities, and is thus inexpensive. Individual replacement teeth can be produced easily and reproducibly from this material using dental technology, so that the term “dental ceramic” has become established for this material.

To overcome the only weakness of this material, namely its brittleness, tooth replacements produced by dental technology have for a long time generally been produced as a classical composite material, e.g. as what is called metal ceramic. A metal-ceramic crown or bridge consists of a metallic framework or substructure and of a so-called veneer of dental ceramic reproducing the tooth shape. When the tooth replacement is fitted, the substructure is fixed directly onto the residual tooth remaining after preparation by the dentist and is often referred to as a (protective) cap. Depending on the material or alloy from which the cap is made, and depending on the method of production (casting, electroforming, i.e. electrochemical deposition), problems in the form of corrosion and resulting discoloration, incompatibility with the body, etc., can occur. For this reason, there has in recent years been increasing development of systems which can produce comparable subconstructions of ceramic materials and process them further using dental technology.

There are a number of functioning systems already available on the dental market. Thus, ceramic caps are produced, for example, by manual application of a slip onto a model stump, subsequent firing, and subsequent infiltration with special glass (VITA In-Ceram) or by hot pressing (Empress, IVOCLAR). There are also systems in which the caps are digitally milled from sintered or presintered ceramic blocks (DCS System, CEREC, etc.). However, a common feature of all fully ceramic systems is that they generally do not achieve an accurate fit of metallic bodies onto the remaining tooth, regardless of whether the bodies have been cast or produced by electrolytic processes. In addition, these systems are usually very expensive to purchase.

The unsatisfactory accuracy of fit of existing all-ceramic systems is mainly due to the shaping methods used. Metallic caps are produced by casting or electrodeposition, so that the metal in molten or dissolved form can optimally match the stump geometry. By contrast, in the case of, for example, CADCAM all-ceramic processes, the required shape has to be milled from solid material according to a digitally recorded data set. However, depending on the digital resolution of the system components, the scanning of the tooth stump and the milling can already have inaccuracies.

A further fundamental difficulty associated with all existing or future systems for producing all-ceramic tooth replacements from sintered ceramic materials in respect of the accuracy of fit of the finished parts is the ceramic shrinkage, i.e. the volume reduction of shaped ceramic parts associated with the densifying sintering process. Although this sintering shrinkage can be reduced within certain limits, it cannot be completely avoided. For this reason, the sintering shrinkage associated with the sintering step is, for example, avoided indirectly by working with already sintered ceramic (CADCAM methods, see above) or seeking to achieve a pore-free solid microstructure in some other way (glass infiltration of the soft, porous ceramic caps in the InCeram process, see above). In electrophoretic deposition of ceramic particles, too, the ceramic shaped part obtained has to be subsequently sintered, so that the indicated problem of sintering shrinkage also occurs here.

The problems indicated particularly affect two-membered or multi-membered all-ceramic dental shaped parts. This is due, among other reasons, to the fact that these dental shaped parts, such as bridges, have greater dimensions, are exposed to greater mechanical loads, and often require greater accuracy of fit. These problems mean that, for example, pressed ceramics, in which glass ceramic is used, or glass-infiltrated oxide ceramics (as discussed above) are not entirely suitable, or are not suitable at all, for the production of bridge constructions. This applies in particular to multi-span bridges in the buccal region.

The object of the invention is therefore to avoid at least some of the discussed, and other, disadvantages 6f the prior art in the production of two-membered or multi-membered all-ceramic dental shaped parts. It is intended, in particular, to make use of the great strength and fracture toughness of a sintered oxide ceramic for two-membered or multi-membered all-ceramic dental shaped parts. In addition, the production of such dental shaped parts should preferably be made substantially simpler. Finally, an especially high accuracy of fit should be achieved while avoiding the disadvantageous effects of the abovementioned sintering shrinkage.

This object is achieved by the method having the features of claim 1 and by the dental shaped part as claimed in claim 15. Preferred embodiments of the method according to the invention and of the dental shaped part according to the invention are set out in dependent claims 2 through 14 and, respectively, 16. Claim 17 concerns and covers a device for electrophoretic deposition of two-membered or multi-membered all-ceramic dental shaped parts according to the invention. Preferred embodiments of this device are described in the dependent claims 18 and 19. The wording of all the claims is hereby incorporated by reference in the content of the present description.

To permit a better understanding of the invention, the production and further processing of dental models will be explained briefly below. The tooth or the teeth which is/are to be provided with a dental shaped part, e.g. bridge or the like, are prepared in a known manner by the dentist. An implant buildup part can also serve as starting point. The dentist takes an impression of this oral situation with the aid of a curable elastomer material. This can be, for example, a silicone polymer. The impression obtained in this way represents a negative model of the preparation carried out by the dentist. This impression, i.e. the negative model, is handed over to the dental technician who makes a casting from this impression with the aid of a suitable modeling material, usually a so-called dental plaster. Setting of the plaster gives a positive model, called the master model, which corresponds precisely to the preparation performed by the dentist. This master model is usually retained as a specimen pattern. It is used for producing one or more working models which are then processed further. The working model is produced by duplication, i.e. a negative model is produced with the aid of a duplicating material, for example silicone polymer, which negative model is then once again filled with dental plaster. A further positive model, namely the working model, is produced in this way.

In the method according to the invention for production of two-membered or multi-membered all-ceramic dental shaped parts, a model is produced from the basic structure for which the dental shaped part is intended, then, with the aid of the model and a suspension of ceramic particles, a ceramic green body is formed, and this green body is sintered, if appropriate after removal from the model. At least some of the dimensions of the model are selected so that the shrinkage which occurs during sintering of the green body is compensated, in order thereby to achieve the desired fit between dental shaped part and basic structure. In preferred embodiments, substantially all dimensions of the model are selected so that the sintering shrinkage is compensated.

In principle, there are various possible ways of compensating for the sintering shrinkage by using the dimensions of the model. In particular in the method according to the invention, in order to compensate for the sintering shrinkage, the model is made of a modeling material with a high linear setting expansion. This modeling material is preferably what is called dental plaster.

In accordance with the prior art, it was hitherto obvious to the skilled person to use a modeling material with the lowest possible expansion upon setting/curing. This is because it is only in this way that the required accuracy of dimensions between the preparation performed by the dentist and the master model or working model can be ensured. For this reason, the setting expansions of, for example, customary modeling materials such as dental plasters are generally very low. This setting expansion can be determined by customary methods according to the known relationships of dilatometry as linear expansion Δl/l₀ or volume expansion ΔV/V₀. The linear expansion of commercial dental plasters, e.g. the change in length experienced by a corresponding plaster body on setting, is less than 0.3%. Very low values are sought in principle. Thus, the linear expansion values of the frequently employed superhard plasters of class IV are ≦0.15%.

By contrast, the modeling material used in the invention for dental purposes has a linear expansion on setting or curing of at least 0.5%, preferably at least 1%. Preferred values for the linear expansion on setting/curing are in the range of 4% to 12%. Within this range, preference is in turn given to values of 8% to 10%.

A modeling material as used in the invention completely contradicts the previous understanding of the person skilled in the art. As has already been explained, it was previously an aim to provide modeling materials with the lowest possible expansion on setting/curing. The invention now intentionally uses modeling materials with relatively high expansions in order in this way to compensate for the sintering shrinkage occurring in the production of all-ceramic dental shaped parts. If the master model or preferably the working model is deliberately “overdimensioned”, the sintering shrinkage can be accepted. If the expansion behavior of the modeling material and the sintering shrinkage behavior of the ceramic are known, an accurately dimensioned all-ceramic dental shaped part can be made available.

The modeling material used according to the invention can in principle consist of a wide variety of substances, which can also be organic in nature. However, in preferred embodiments of the invention, the modeling material consists mainly, and in particular entirely, of inorganic substances. If so desired, additives can be present which influence the setting expansion or other chemical and physical properties of the modeling material. These additives, too, are preferably inorganic substances.

It is particularly preferable for the modeling material to consist entirely or mainly of gypsum plaster. These are then generally what are called dental plasters, which take account of the particular requirements in the dental field, for example in terms of modelability and so-called drawing accuracy. In terms of its overall properties, gypsum plaster remains the modeling material of choice for the dental technician. To achieve accurate processing appropriate to the product, gypsum plaster is suitable for all types of models in dental technology and their production.

Finely pulverulent dental plaster, chemically CaSO₄.½H₂O (“calcium sulfate hemihydrate”), is mixed with a defined amount of water (H₂O) and used for producing plaster duplicates of teeth or dentures. The plaster slurry formed upon mixing is introduced into a readily removable mold made of duplicating material (usually silicone) which corresponds to the impression of the oral situation. The mixture then sets by reaction with water to form CaSO₄.2H₂O, that is to say calcium sulfate dihydrate:

CaSO₄.½H₂O+1½H₂O→CaSO₄.2H₂O

As can be seen from the chemical formula, part of the water added is bound chemically as “water of crystallization” upon setting. During the setting process, the plaster solidifies and becomes hard. Heat is liberated and the process is accompanied by a reproducible expansion which can be determined as linear expansion Δ1/1 or as volume expansion ΔV/V. This expansion is deliberately set to a high value in the dental plasters according to the invention.

When examined in detail, the setting process is a sum of individual processes. Mixing the dry plaster powder with water results in a supersaturated solution of calcium sulfate hemihydrate which takes up water and turns into dihydrate. Starting from crystallization nuclei, clusters grow by uptake of further dihydrate molecules and continue to grow to form crystals. The formation of new nuclei and the continual growth of the dihydrate crystals thus slowly produces an evermore solid network of mutually interlocking and interpenetrating crystals whose volume is greater than the sum of the individual crystal volumes. This is reflected macroscopically in that the plaster experiences the abovementioned (volume) expansion upon setting. In addition, energy is released in the form of heat.

As has already been mentioned, the modeling material used can contain additives which influence in particular the setting and curing process. Such additives influence parameters such as the expansion upon setting/curing, the duration of setting/curing, the hardness of the model obtained, and the like. The additives are preferably inorganic substances, in particular salts. Thus, for example, addition of sodium chloride can increase the volume expansion of dental plasters upon setting. However, preference is given to using silicates as an additive for increasing the volume expansion. Such silicates can, for example, be used in the form of silica sol. It is possible to add the silicates to the gypsum plaster powder either directly or in the form of silicate-containing make-up liquids.

The expansion of the model which is produced in the method according to the invention can be additionally increased in a desirable manner by dipping the shaped model at least partially, preferably completely, into a liquid, in particular a solvent, for a defined time during setting/curing. The liquid is preferably the liquid with which the modeling material has been admixed, in particular stirred, to bring it into the slurry or paste form necessary for casting into the mold. When dental plaster is used as modeling material, this liquid is usually water. In these cases, the plaster material is accordingly allowed to set under water.

In the method according to the invention, it is further preferred to at least partially dry the model obtained after setting/curing. This is usually done by simply allowing the model to stand in air, for which a period of from 0.5 hour to 3 hours is usually sufficient. During drying, the water which is not chemically bound as water of crystallization in the plaster evaporates. The drying process can be aided by employing elevated temperatures. In preferred embodiments, at least one microwave drying step is employed for drying the models. The microwave drying generally takes only a few minutes and can be carried out in a customary domestic microwave oven.

In the method according to the invention, a suspension of ceramic particles, the so-called ceramic slip, is then applied to the model, usually a working model. Because of the volume expansion which has occurred, this working model accordingly has greater dimensions than the basic structure prepared in the mouth by the dentist. Accordingly, this working model usually also has greater dimensions than the master model which is intended to exactly reproduce the situation in the mouth and is advantageously not produced from the modeling material. The greater dimensions of the working model onto which the ceramic slip is applied already take account of the sintering shrinkage occurring in the sintering step.

In this context, it may be mentioned that the working model finally used for application of the ceramic slip can, according to the invention, also be produced in a plurality of passes, depending on which modeling material is used. In this way, the desired greater dimensions of the working model to compensate for the sintering shrinkage can be approached gradually or, if appropriate, it may even be possible to produce various all-ceramic shaped parts and test their fit to the master model.

The method mentioned at the outset, in which a model is produced from the basic structure, then a ceramic green body is formed with the aid of the model and a suspension of ceramic particles, and this green body is sintered, in particular the method as described above, can preferably be arranged so that, upon formation of the green body, at least two members of the dental shaped part are formed simultaneously from the ceramic particles in one work step. In particular, in such embodiments, all of the members of the dental shaped part are formed simultaneously. This procedure, which will be explained in detail later, has the advantage that the production method as a whole is made simpler and faster.

To produce the green body, the ceramic suspension can preferably, according to the invention, be applied to the model (working model) by electrophoretic deposition. The principles of and the procedure for such an electrophoretic deposition are known to the person skilled in the art. In this procedure, a powder, in this case a ceramic powder, dispersed in a liquid is deposited on the model as a precompacted layer with the aid of an electric field. The ceramic body obtained in this way, namely the green body, is sintered, if appropriate after drying and removal from the model.

In electrophoretic shaping, the model of the oral situation (working model) to which an electric contact has been applied, e.g. by means of conductive silver varnish, is connected as electrode into an electric circuit. As counterelectrode, use is made of, for example, a Pt electrode whose shape can be varied according to the shape of the model so as to achieve a highly homogeneous electric field for the entire model.

The deposition of the ceramic slip on the working model is carried out at constant voltage or at constant current, normally over a period of from 1 to 60 minutes. Typical values for the deposition voltage and the deposition currents are from 1 to 100 V and from 1 to 500 mA, respectively. The green densities obtained using electrophoretic deposition are usually greater than 70%, preferably greater than 80%, of the theoretical density. Electrophoretic deposition can, if appropriate, be carried out in an automated manner with the aid of an appropriate apparatus.

The suspensions of ceramic particles used are suspensions of dispersed ceramic powders in suitable solvents. As indicated above, these are also referred to as ceramic slips. As solvents, preference is given to using polar solvents, in particular water, alcohols and mixtures thereof, or mixtures of water with alcohols. Preference is given to using polar solvents having dielectric constants in the range from 15 to 85, preferably in the range from 15 to 20.

The ceramic particles are preferably oxide ceramic particles, in particular aluminum oxide (Al₂O₃) particles and/or zirconium oxide (ZrO₂) particles, or mixtures thereof. The particle sizes of the ceramic particles are preferably in the range from 1 nm to 100 μm, preferably from 100 nm to 10 μm. In particular, the ceramic particles are present in the suspension in an amount of from 10 to 90 percent by weight, preferably from 40 to 60 percent by weight, based on the total weight of the suspension.

In further embodiments, at least 2 fractions of ceramic particles having different mean particle sizes can be present within the suspension. In this way, it is possible to increase the density of the deposited green body, since the ceramic particles having a smaller mean particle size at least partially fill the interstices between the ceramic particles having a larger mean particle size. It is known that the particle size distribution of a fraction of ceramic particles having a particular mean particle size conforms to a Gaussian distribution. Accordingly, the two or more Gaussian curves are shifted relative to one another in the embodiments described (to use the same analogy).

The suspension usually further comprises binders which preferably comprise at least one polyvinyl alcohol or at least one polyvinyl butyral. Such binders serve, inter alia, to improve both the drying behavior and the strengths of the resulting green bodies. The binders are preferably present in the suspension in amounts of from 0.1 to 20 percent by weight, in particular from 0.2 to 10 percent by weight, based on the solids content of the suspension.

The slips used are characterized by viscosities in the range from 1 mPa*s to 50 mPa*s, preferably in the range from 3 to 10 mPa*s, at a shear rate of 600 s⁻¹.

In the invention, those parts of the model which correspond to the abutments, in particular to the abutment teeth, preferably have a stump-like shape. In particular, these parts have the shape of a small cap which, when finished, can be fitted onto the associated tooth stump or onto another corresponding basic structure.

Moreover, those parts of the model which correspond to the side members or the bridge members of the model are preferably designed as a hollow mold. This means that in such embodiments the ceramic suspension can be introduced into this hollow mold to produce the green body. In the embodiments with a hollow mold, said hollow mold is secured to those parts of the model which correspond to the abutments.

In the above-described preferred embodiments, those parts of the model which correspond to the abutments are made of what is called dental plaster. This is preferably the above-described dental plaster with the high linear setting expansion. Moreover, in these embodiments, the hollow mold is preferably made of a material that can be modeled by dental technology. This material is in particular what is called dental wax. In the case of the hollow mold too, the sintering shrinkage of the introduced ceramic, which occurs later, can also be taken into account through selecting suitably greater dimensions.

The hollow mold provided in the indicated embodiments is preferably made up of three shells, in particular with a bottom shell and with two side shells closing the hollow mold at the top. This three-shell design facilitates production of the hollow mold and thus of the model, as will be explained in more detail below.

The above-described securing of the hollow mold to the parts of the model which correspond to the abutments is preferably done with the aid of a dental modeling material, in particular with the aid of dental waxes.

A method which is particularly preferred according to the invention and is used to produce a framework element for bridges comprises the following method steps:

First, a prefabricated bridge member, or the model of such a bridge member, is placed and modeled-in between two (prefabricated) parts of the model which correspond to the abutments. In a subsequent step, the bridge member or its model, including the points of connection to the abutment parts, is modeled-in with the dental modeling material (in particular dental wax), preferably from the base up to the anatomical equator. The modeled element obtained in this way is taken off the model, and the bridge member or its model is removed from the remaining model/working model. The modeled element initially taken off is then once again placed in the original position on the remaining model and fixed, preferably with dental wax. The fixed modeled element is then shaped, in particular with the aid of a so-called wax probe, to give a complete hollow mold. Finally, the ceramic green body is formed with the aid of the resulting complete model of abutments and bridge member and with the aid of a suspension of ceramic particles.

The green body produced in the course of the method according to the invention preferably has an average layer thickness of from 0.2 to 2 mm, in particular from 0.8 to 1.2 mm. In this way, the desired layer thicknesses of the all-ceramic shaped part after the sintering step can be achieved.

The ceramic green body usually has a green density of at least 70% and is sintered at temperatures determined by the ceramic materials used. The sintering temperature preferably lies in the range from 1100° C. to 1700° C., in particular from 1500° C. to 1700° C. The sintering temperature is preferably about 1600° C.

The sintering time is likewise chosen, for example, as a function of the ceramic material used. Here, preferred sintering times are from 2 to 10 hours, in particular from 2 to 6 hours. In further preferred embodiments, sintering is carried out for about 5 hours.

To achieve a homogeneous temperature distribution in the green body, the latter is brought gradually to the final sintering temperature. Preferred heating rates here are from 1 to 20° C. per minute, in particular from 5 to 10° C. per minute. Within the latter range, heating rates of from 5 to 7.5° C. per minute are most preferred.

The preferred procedure in the sintering step is to dry the working model, together with the green body deposited thereon, in air at room temperature and then to transfer it to the furnace. There, the working model together with the green body is heated to about 9000C, for which it is possible to use a comparatively low heating rate. This heating can be carried out in steps, it being possible to provide for holding times at the appropriate temperatures. This heating results in presintering of the green body, with the gypsum material of the working material shrinking because the gypsum loses some of its water of crystallization. The working model together with the green body is then briefly taken from the furnace and the green body is detached from the working model. This occurs easily since the working model has shrunk, as described. The presintered green body, for example in the form of a cap, is then put back in the furnace. The furnace is then brought to the final sintering temperature, preferably at a comparatively high heating rate, and the shaped part is fully sintered.

After the sintering step, all-ceramic shaped parts with densities of more than 90% of the theoretical density, preferably more than 95% of the theoretical density, are obtained. Such all-ceramic parts, for example in the form of a bridge substructure, can then be provided in a customary manner, like a metal cap, with veneering ceramic and fired. This produces the final tooth replacement which is, for example, fitted in the form of a bridge into the patient's mouth. It is of course also possible for the tooth replacement produced in this way to be fitted on dental superstructures, for example implant parts.

The invention also covers the dental shaped part which can be produced in accordance with any of the embodiments of the method according to the invention. This dental shaped part can preferably be produced as a one-piece part, in particular by electrophoretic deposition.

Finally, the invention also covers a device for electrophoretic deposition of two-membered or multi-membered all-ceramic dental shaped parts, in particular of framework elements for bridges and the like. This device can comprise customary components of such an arrangement for electrophoretic deposition, such as a current/voltage source, controlling and regulating means, deposition vessel, counterelectrode, contact-making arrangements and the like. In addition, according to the invention, this device comprises an auxiliary electrode which can preferably be connected as an anode and which can be arranged on the model used for the deposition near a connection point between abutment and side member/bridge member. In preferred embodiments of this device, two auxiliary electrodes are provided which can be arranged near the two connection points between abutments and bridge member. The auxiliary electrodes at least partially surround the corresponding connection points.

Further features of the invention will become evident from the following example and from the figure, in conjunction with the dependent claims. The individual features can in each case be realized either in isolation or in combinations of two or more thereof.

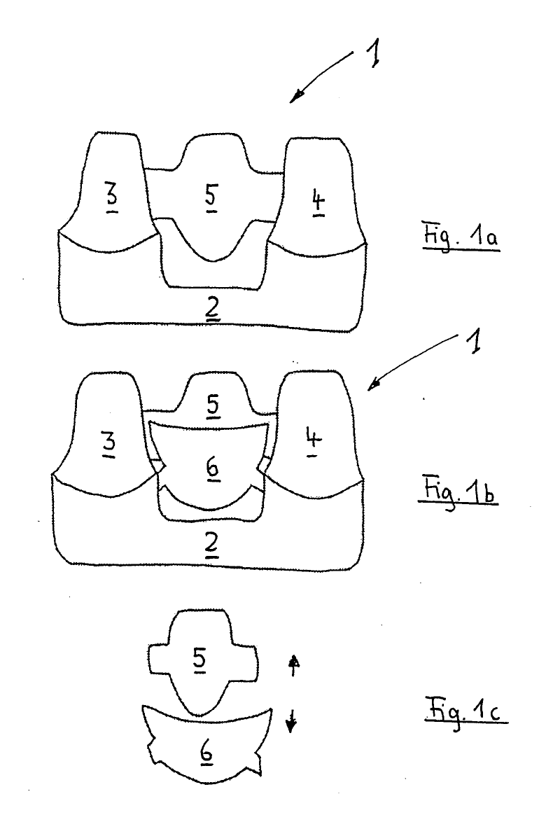

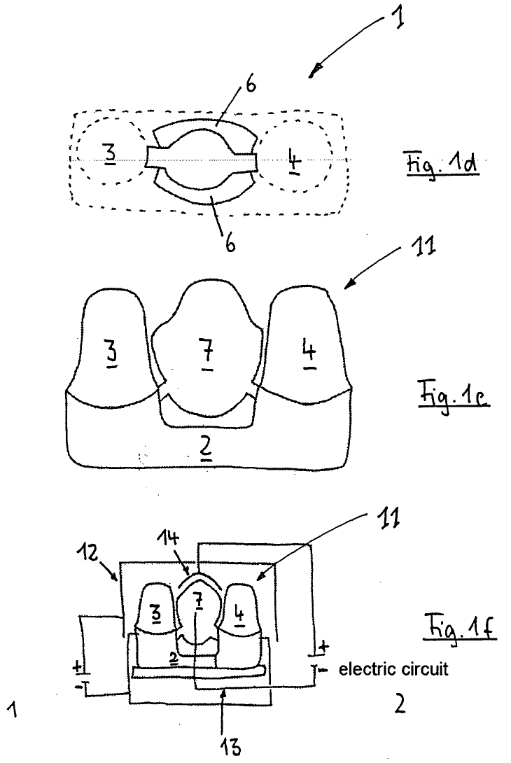

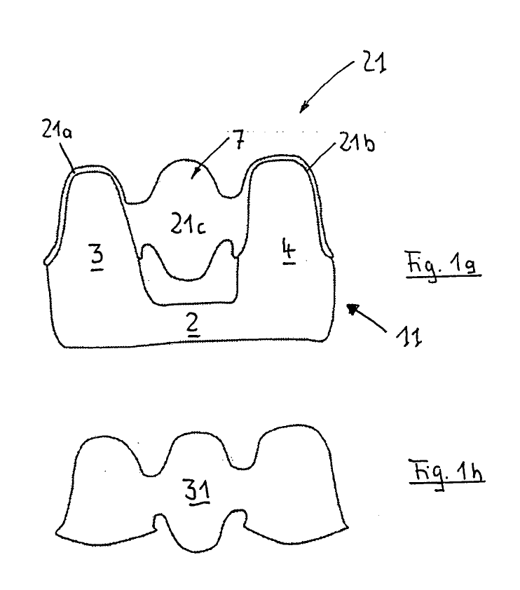

In the drawings FIG. 1a to FIG. 1h show the method steps in a preferred embodiment of the method according to the invention.

### EXAMPLE

### 1. Production of Suspensions of Ceramic Particles

1.1 Slip Production with Aluminum Oxide Powder

To produce an aluminum oxide slip, 0.75 g of Na₂P₄O₇*10H₂O is first added as dispersant to 100 g of deionized water and dissolved by stirring with the aid of a magnetic stirrer. 100 g of aluminum oxide powder with a primary particle size (particle size in the non-agglomerated state) of ca. 0.6 μm are then added in portions with constant stirring. The suspension thus obtained is dispersed for 5 minutes in a subsequent work step by means of ultrasound treatment with 20 kHz and an output of 450 watt. 5 g of polyvinyl alcohol are then added to the suspension. The resulting ceramic slip is homogenized by renewed ultrasound treatment. Chemicals used: Aluminum oxide powder CT 3000 SG (ALCOA; MERCK); sodium pyrophosphate decahydrate (RIEDEL DE HAEN); polyvinyl alcohol, molecular weight 72000 (CLARIANT).

1.2 Slip Production with Zirconium Dioxide Powder

100 g of zirconium oxide powder are added in portions, with stirring to 100 g of ethanol in which 1 g of acetyl acetone has previously been dissolved with the aid of a magnetic stirrer. The primary particle size (particle size in the non-agglomerated state) of the zirconium dioxide powder used here is ca. 0.6 μm. Ultrasound treatment is then carried out for 5 minutes to obtain complete deagglomeration of the suspension produced. 5 g of polyvinyl butyral are added to the resulting suspension. Homogenization of the obtained slip is achieved by renewed ultrasound treatment.

Chemicals used: Zirconium oxide powder SC 15 (MEL CHEMICALS); acetyl acetone (RIEDEL DE HAEN); polyvinyl butyral, molecular weight 70000 (CLARINANT).

### 2. Production of an All-Ceramic Framework Element for a Bridge

As has already been mentioned in the description, the dentist, usually after carrying out suitable preparation work, takes an impression of the oral situation using a curable elastomer material. The hardened impression is then cast by the dental technician using a model material, usually dental plaster. In doing this, a standard dental plaster with low linear setting expansion is expediently used. The so-called master model is obtained after the plaster has set. By duplication of this master model, in the manner described below, at least one working model is obtained on which the all-ceramic framework element for a bridge can be produced by the method according to the invention.

In the procedure mentioned, the dental technician, before duplicating the master model, usually exposes the preparation limit, checks the bridge abutment stumps for cavities, grinding fissures or the like, and, if appropriate, fills the latter out with dental wax or a suitable polymer. The aforementioned duplication of the master model then takes place. The duplicate mold (negative mold) taken from the master model using silicone polymer is cast with a special plaster whose linear setting expansion is such that it compensates for the sintering shrinkage which occurs during sintering of the green body later obtained.

The working model 1 thus obtained is shown in FIG. 1a. It consists principally of the base 2 and of the two parts 3 and 4 which correspond to the abutment teeth or abutment teeth stumps. It will be noted once more that, because of the use of the dental plaster with a high linear setting expansion, the parts 3 and 4 of the working model 2 have greater dimensions than the corresponding parts of the master model (not shown). The master model exactly reproduces the oral situation in terms of its dimensions.

Next, a bridge member 5 is then modeled into the working model 1 with base 2 and abutment tooth parts 3 and 4. This bridge member 5 corresponds to a reduced anatomical tooth shape. The later ceramic sintering shrinkage can already be taken into account by greater dimensions of the bridge member 5. Modeling is carried out using a polymer, for example the so-called pattern resin from the company GC, a PMMA (polymethyl methacrylate) polymer. Alternatively, prefabricated bridge members made of dental wax or polymer can be used. In each case, the bridge member is modeled-in between the bridge abutment stumps while taking into account the actual situation in the patient's mouth. That is to say, account is taken of the teeth to be replaced, the residual denture, the so-called antagonists, the so-called side shift, and other factors. At the same time, the connection points between bridge member and bridge abutment stumps, the so-called bridge connectors, are dimensioned as large as possible in order subsequently to ensure a high degree of stability of the framework element.

In the next method step, illustrated in FIG. 1b, the bridge member and bridge connectors are modeled-in, from the base to the anatomical equator, with a dental wax which fires without leaving residues, to give a wax modeled element 6.

This wax modeled element 6 is then removed from the bridge member 5. Whereas the bridge member 5 represents a positive mold, the wax modeled element 6 is a negative mold. After the wax modeled element 6 has been removed from the bridge member 5, this bridge member 5 is also once again removed from the bridge abutment stumps 3 and 4. This is indicated in FIG. 1c by the arrows.

After the bridge member 5 has been removed from the bridge abutment stumps 3 and 4, and thus from the working model 1, the wax modeled element 6 (negative mold of the bridge member 5) is again placed in its original position between the bridge abutment stumps 3 and 4 on the working model 1 and fixed with dental wax. This method step is shown in FIG. 1d, specifically, for better understanding, in a view from above, i.e. from the occlusal direction. By replacing the wax modeled element 6 onto the working model 1, the information concerning the bridge member 5 and the bridge connectors is transferred as negative to the working model 1.

Next, the final height of the bridge member 5 is set by finishing the wax mold walls in the occlusal direction, which is illustrated in FIG. 1e. Here, the remainder of the bridge member required in the occlusal direction is modeled by means of what is called a wax probe. In this way, a hollow mold 7 connected to the working model 1 is obtained between the bridge abutment stumps 3 and 4 of the working model 1. This hollow mold 7 corresponds in shape to the originally used bridge member 5. The hollow mold 7 is open in the direction of the bridge abutment stumps 3 and 4.

The situation illustrated in FIG. 1e shows the modified working model 11 thus obtained, from which a ceramic green body is produced. As is illustrated in FIG. 1e, the modified working model 11 consists principally of the base 2, the parts 3 and 4 corresponding to the bridge abutment stumps, and the hollow mold 7 which is arranged between the parts 3 and 4 and reproduces the shape of the bridge member as negative mold.

The modified working model 11 is separated horizontally in the lower part with a diamond separating disk, without damaging the hollow mold 7. The downwardly open gap which results is filled with dental wax which burns without residue and the working model 11 modified in this way is bonded to a stable support, in the present case made of aluminum oxide. The preparation areas of the parts 3 and 4 corresponding to the abutment teeth and the insides of the hollow mold 7 are coated with conductive silver varnish and contacted via copper leads/copper rods (not shown). The model base (support) is expediently covered with a varnish in order to obtain defined ceramic depositions in the cervical area too.

FIG. 1f illustrates the situation of electrophoretic deposition of the ceramic from a ceramic slip, which has been produced for example in 1.1 and 1.2. Accordingly, the modified working model 11, called the deposition model, is coupled as cathode into an electric circuit. In a first electric circuit (electric circuit 1), the parts 3 and 4 of the working model 11 which correspond to the abutment teeth are coupled as cathode (negative pole), and a cover-like electrode 12 spanning the whole of the working model 11 as counterelectrode (anode, positive pole). A second electric circuit (electric circuit 2) is further provided for increased deposition in the area of the hollow mold 7, specifically with the aid of a further cathode 13 (negative pole) contacted directly to the hollow mold 7 and with the aid of the auxiliary electrode 14 (anode, positive pole) spanning the hollow mold 7. The anodically connected auxiliary electrode 14 is here designed flat like a lid or a hood, in order to ensure coverage of the largest possible surface area of the hollow mold 7 with the associated electric field.

The arrangement shown in FIG. 1f, including working model 11, is immersed for electrophoretic deposition into the ceramic slip and the two electric circuits are closed. In the present case, a constant voltage of 14V is applied on both electric circuits. This gives an initial current of 3.7 mA in electric circuit 1 and an initial current of 2.5 mA in electric circuit 2. Deposition is then effected simultaneously. However, the electrophoretic deposition on the parts 3 and 4 (current circuit 1) corresponding to the abutment teeth is ended after just 5 minutes, in order to ensure that the layer of the applied ceramic material obtained is not too thick. In the hollow mold 7 (electric circuit 2), deposition continues 15 minutes longer, i.e. for a total time of 20 minutes. This is done to ensure that the thickest possible ceramic layers are deposited at the connection points between bridge member and abutment teeth. At the end of the electrophoretic deposition, the currents are still 1.3 mA in electric circuit 1 and 0.9 mA in electric circuit 2. As has already been mentioned, the voltage values are maintained constant at 14 V over the entire deposition time.

After the deposition, the working model 11 and green body are removed and the connection between contact (copper rod) and green body is separated by means of a fine-grain diamond cutter. The copper rods are removed and the cervical area is trimmed with a silicone polisher at a low speed and low bearing pressure.

The situation after electrophoretic deposition is illustrated in FIG. 1g. FIG. 1g shows, in cross section, the modified working model (deposition model) 11 and the green body 21 deposited thereon. As before, the modified working model 11 consists of the base 2, the parts 3 and 4 corresponding to the abutment teeth/abutment stumps, and the hollow body 7 modeled from wax. The one-piece green body 21 consists of the two cap-like parts 21a and 21b which are connected to one another via the ceramic part 21c formed in the inside of the hollow body 7.

To separate the green body 21 from the modified working model 11, the whole body comprising working model 11 and green body 21 is subjected to a first temperature treatment. In this temperature treatment, the wax of the hollow body 7 burns without leaving residues on the one hand, and the dental plaster of the rest of the working model comprising base 2 and parts 3 and 4 is dewatered on the other hand. The volume reduction linked to this dewatering effects release of the green body 21 from the rest of the working model. In this first temperature treatment, an end temperature of 900° C. is reached in the present case. This involves initial heating at a rate of 2° C. per minute to a temperature of 70° C. and maintaining this temperature for 30 minutes. The wax of the hollow body 7 thus melts. Then, heating is continued at a rate of 2° C. per minute to a temperature of 600° C., and directly thereafter at a heating rate of 5° C. per minute to the end temperature of 900° C. Here, the holding time is one hour. The whole body is then allowed to cool and the heat-treated green body 21 is removed from the rest of the working model.

The green body 21 thus obtained is then densely sintered in a sinter firing to give the final bridge framework element 31. By means of this sinter firing, the bridge framework element 31 acquires its final shape and strength. The corresponding framework element 31 is illustrated once again in FIG. 1h. In the present example, heating is initially carried out at a rate of 10° C. per minute up to 900° C., and directly thereafter at a rate of 5° C. per minute to an end temperature of 1600° C. The holding time at 1600° C. is 4 hours. The subsequent cooling takes place at a temperature reduction rate of 5° C. per minute to a temperature of 900° C. The sintering furnace is then allowed to cool freely to room temperature.

Through using the method according to the invention, the bridge framework element 31 according to the invention has an excellent fit with the parts of the master model which correspond to the abutment tooth stumps. To produce the final tooth replacement, the bridge framework element 31 is veneered with a dental ceramic which has a thermal expansion coefficient matching the ceramic of the framework element. As has been mentioned, the whole bridge framework is produced according to the invention in one shaping operation, in this case an electrophoretic shaping operation. There is no more need to subsequently connect bridge member and abutment tooth parts to one another. As has also been shown, the electrophoretic deposition requires no expensive equipment, but instead can be carried out using a relatively simple apparatus. This means the method according to the invention is of great interest from the point of view of cost.

1. A method for producing two-membered or multi-membered all-ceramic dental shaped parts, in particular framework elements for bridges (31) and the like, in which method a model (11) is produced from the basic structure for which the dental shaped part is intended, and, with the aid of the model (11) and a suspension of ceramic particles, a ceramic green body (21) is formed, and the ceramic green body (21) is sintered, if appropriate after removal from the model (11), at least some of the dimensions of the model being selected so that the shrinkage which occurs during sintering of the green body is compensated, in order to achieve the desired fit between dental shaped part and basic structure.

2. The method as claimed in claim 1, characterized in that substantially all dimensions of the model (11) are selected so that the sintering shrinkage is compensated.

3. The method as claimed in claim 1 or claim 2, characterized in that, in order to compensate for the sintering shrinkage, the model is made of a modeling material, in particular of what is called dental plaster, with a high linear setting expansion.

4. The method as claimed in claim 3, characterized in that the modeling material has a linear expansion of at least 0.5%, preferably of from 4% to 12%, in particular of from 8% to 10%.

5. A method for producing two-membered or multi-membered all-ceramic dental shaped parts, in particular framework elements for bridges and the like, in which method a model is produced from the basic structure for which the dental shaped part is intended, and, with the aid of the model and a suspension of ceramic particles, a ceramic green body is formed, and the ceramic green body is sintered, in particular the method as claimed in one of the preceding claims, in which, upon formation of the green body, at least two members, preferably all the members, of the dental shaped part are formed simultaneously from the ceramic particles in one work step.

6. The method as claimed in one of the preceding claims, characterized in that the green body (21) is formed from the ceramic particles by electrophoretic deposition.

7. The method as claimed in one of the preceding claims, characterized in that the parts (3, 4) of the model (11) which correspond to the abutments, in particular to abutment teeth, have a stump-like shape, in particular the shape of a cap.

8. The method as claimed in one of the preceding claims, characterized in that the parts of the model which correspond to the side members or bridge members are designed as a hollow mold (7).

9. The method as claimed in claim 8, characterized in that the hollow mold (7) is secured to the parts (3, 4) of the model which correspond to the abutments.

10. The method as claimed in one of claims 7 through 9, characterized in that the parts of the model which correspond to the abutments are made of what is called dental plaster, in particular of a dental plaster with a high linear setting expansion.

11. The method as claimed in one of claims 8 through 10, characterized in that the hollow mold is made of a dental modeling material, preferably of what is called a dental wax.

12. The method as claimed in one of claims 8 through 11, characterized in that the hollow mold is made up of three shells, preferably with a bottom shell and with two side shells closing the hollow mold at the top.

13. The method as claimed in one of claims 8 through 12, characterized in that the hollow mold is secured to the parts of the model corresponding to the abutments with the aid of a dental modeling material, preferably with the aid of a dental wax.

14. The method as claimed in one of the preceding claims, characterized in that, in order to produce a framework element for bridges,
a) a bridge member (5), or the model of a bridge member, is placed and modeled-in between two parts (3, 4) of the work model (1) which correspond to the abutments,
b) the bridge member (5) or its model, including the points of connection to the abutment parts, is modeled-in with a dental modeling material, preferably with dental wax, preferably from the base up to the anatomical equator,
c) the modeled element (6) obtained in accordance with b) is taken off and the bridge member (5) or its model is removed from the work model (1),
d) the modeled element (6) obtained in accordance with b) is once again placed in the original position on the work model (1) and fixed, preferably with dental wax,
e) the fixed modeled element (6) is shaped, in particular with the aid of a wax probe, to give a complete hollow mold (7), and
f) said ceramic green body (21) is formed with the aid of the resulting model of abutments and bridge member and with the aid of a suspension of ceramic particles.

15. A dental shaped part which can be produced using the method as claimed in one of the preceding claims.

16. The dental shaped part as claimed in claim 15, characterized in that it can be produced as a one-piece component, in particular by electrophoretic deposition.

17. A device for electrophoretic deposition of two-membered or multi-membered all-ceramic dental shaped parts, in particular of framework elements for bridges and the like, characterized in that, in addition to customary components such as a current/voltage source, controlling and regulating means, deposition vessel, counterelectrode, contact-making arrangements and the like, it has at least one auxiliary electrode which can be connected as anode and which can be arranged on the model used for the deposition near a connection point between abutment and side member/bridge member.

18. The device as claimed in claim 17, characterized in that at least one auxiliary electrode and preferably two auxiliary electrodes are provided which can be arranged near the connection points in the interdental space between the bridge abutments.

19. The device as claimed in claim 17 or claim 18, characterized in that the auxiliary electrodes at least partially surround the corresponding connection points.
